(19) United States
(12) Patent Application Publication
(10) Pub. No.: US 2017/0201561 A1
(43) Pub. Date: Jul. 13, 2017

(54) MULTIMEDIA CONNECTION SERVICE SYSTEM UTILIZING AV DEVICE AND USER DEVICE

(71) Applicant: Tellybean Oy, Helsingfors (FI)

(72) Inventors: Cami Hongell, Helsinki (FI); Lucas Lafarga, Helsinki (FI)

(21) Appl. No.: 14/994,609

(22) Filed: Jan. 13, 2016

(51) Int. Cl. H04L 29/06; H04W 12/06; H04W 4/00; H04W 76/02; H04W 4/20

(52) U.S. Cl. CPC H04L 65/601; H04W 76/023; H04W 4/20; H04W 4/008; H04W 12/06

(57) ABSTRACT

A method for providing a multimedia connection between a first user of a user device and a second user of a peer device comprises connecting the user device via a wide-area public communication network to the peer device and via a local connection or the wide-area public communication network to a local AV device associated with the user device; capturing audio and video input signals from the first user using the user device; encoding at least a part of the captured audio and video input signals from the first user by the user device to provide encoded audio and video input signals; transmitting the encoded audio and video input signals from the user device to the peer device, wherein the encoded audio and video input signals are decoded and provided for the second user of the peer device; and receiving encoded audio and video input signals from the second user of the peer device at the local AV device, wherein the audio and video input signals from the second user of the peer device are decoded and provided for the first user using the AV device.

### TECHNICAL FIELD

The present application generally relates to a method, a system and an apparatus for providing a multimedia connection service.

### BRIEF DESCRIPTION OF RELATED DEVELOPMENTS

Multimedia connections are widely used as a communication method providing people not only speech but streaming video of the other party as well. High-speed telecommunication networks enable multimedia connection activation between computers and cellular phones.

TV screens are great for consuming different types of audiovisual media, either using the capabilities of the TV itself or the capabilities of a connected set-top box. However, most TVs and set-top boxes are not designed for or even technically capable of allowing users to generate and send their own audiovisual content at sufficiently good quality. This has meant that for example video calling using a TV has not become a widely spread service. This is mainly due to inadequate video encoding capabilities and lack of webcam support.

For a user to generate audiovisual content and to use it as a component of a service consumed on the TV, and send it to a peer user, at least two things are required: I) capturing audio and video content and II) encoding the captured content. For example, live audio and video input from a user may be used as a central component of a service consumed on the big screen of a TV. Examples of such services include video calling and incorporating live video of a user as part of a broadcast of the user playing a game.

Up until recently, in most use cases, such as Skype on TV, both the capturing of the content and encoding it has been done on a webcam device connected to the TV. The problem with this approach has been that the required camera has been expensive, often 100-150$ and the solution has required a lot of specific product development to ensure compatibility between the camera and the hardware.

Recently, some manufacturers of set-top boxes and TVs have started to implement standardized camera support (UVC—Universal Video Class), meaning that in principle any USB-webcam should be compatible. The benefit of this development has been that the cameras are no longer hardware specific, but generic.

However, this is only a start to solving the problem and a few problems remain: I) first, only a small minority of new devices that come out to market have UVC-camera support, II) second, even if the device has UVC-camera support, the user often does not have a USB camera, and III) third, even if there is camera support and a compatible camera, the video encoding capabilities of the TV or the set-top box typically limit the quality of the encoded content.

Thus, a solution is needed to allow a user to capture and encode audio and video that is easy to set-up, easy to use, low maintenance, low-cost and highly functional.

### SUMMARY

According to a first example aspect of the disclosed embodiments there is provided a method for providing a multimedia connection between a first user of a user device and a second user of a peer device comprising:

connecting the user device via a wide-area public communication network to the peer device and via a local connection or the wide-area public communication network to a local AV device associated with the user device;

capturing audio and video input signals from the first user using the user device;

encoding at least a part of the captured audio and video input signals from the first user by the user device to provide encoded audio and video input signals;

transmitting the encoded audio and video input signals from the user device to the peer device, wherein the encoded audio and video input signals are decoded and provided for the second user of the peer device; and

receiving encoded audio and video input signals from the second user of the peer device at the local AV device, wherein the audio and video input signals from the second user of the peer device are decoded and provided for the first user using the AV device.

In an embodiment, the method further comprises:

receiving audio signal from the second user of the peer device at the user device, wherein the user device is configured to provide echo cancellation based on the audio signal from the second user to reduce transmission of the audio signal of the second user back to the peer device.

In an embodiment, the method further comprises:

pairing the user device and the AV device via the local connection to provide association between the devices for the multimedia connection.

In an embodiment, the method further comprises:

pairing the user device and the AV device via the wide-area public communication network to provide association between the devices for the multimedia connection.

In an embodiment, the user device comprises a communication interface, a memory and a processor, configured to be capable of downloading and locally executing software program code, wherein the software program code comprising a client application for the multimedia connection.

In an embodiment, the AV device is associated with the user device using at least one of the following:

a unique user identifier;

an e-mail address;

a token, such as a text string or a QR code; and

a pairing code generated by an external service, such as Google Nearby API.

In an embodiment, the method further comprises:

transmitting the encoded audio and video input signals from the user device to the peer device directly without travelling through the AV device.

In an embodiment, the method further comprises:

transmitting the encoded audio and video input signals from the user device to the peer device by relaying the encoded audio and video input signals through the AV device without decoding.

In an embodiment, the method further comprises:

selecting, by the first user, at least one of a plurality of applications operating in the user device to share with at least the peer device; and

initiating application sharing in the user device for the selected application, wherein an image of data displayed at the user device is transmitted as video input signals from the first user for display at the peer device, and wherein the second user is permitted to access or observe an initiated application, but is not permitted to perform any unauthorized operations on an application being shared.

In an embodiment, the first user provides selection information via user interface of the user device, and the selection information is configured to control whether video input signals captured from a camera of the user device or from the shared application is encoded as video input signals from the first user by the user device to provide encoded audio and video input signals.

In an embodiment, the method further comprises:

selecting, by the first user, at least one of a plurality of applications operating in the user device to share with at least the peer device; and

initiating application sharing in the user device for the selected application, wherein at least part of data provided by the shared application is transmitted combined with video input signals from the first user for augmented display at the peer device, and wherein the second user is permitted to access or observe an initiated application, but is not permitted to perform any unauthorized operations on an application being shared.

In an embodiment, the first user provides selection information via user interface of the user device, and the selection information is configured to control whether video input signals captured from a camera of the user device only, or as augmented with the data provided by the shared application, is encoded as video input signals from the first user by the user device to provide encoded audio and video input signals.

In an embodiment, the method further comprises:

generating from the video input signals captured from a camera of the user device as a first video stream; and

generating from the at least part of the data provided by the shared application as a second video stream.

In an embodiment, the method further comprises:

combining the first and the second video stream to provide the video input signals for encoding.

In an embodiment, the method further comprises:

encoding the first and the second video stream separately to provide first and second encoded video input; and

transmitting the encoded audio and the first and the second video input signals from the user device to the peer device, wherein the encoded audio and video input signals are decoded and provided for the second user of the peer device.

According to a second example aspect of disclosed embodiments there is provided a user device for providing a multimedia connection comprising:

a camera;

a microphone;

a communication interface for communicating with an AV device and

a peer device;

at least one processor; and

at least one memory including computer program code;

the at least one memory and the computer program code configured to, with the at least one processor, cause the user device to:

connect the user device via a wide-area public communication network to the peer device and via a local connection or the wide-area public communication network to a local AV device associated with the user device;

capture audio and video input signals from a first user using the camera and the microphone;

encode at least a part of the captured audio and video input signals to provide encoded audio and video input signals; and

transmit the encoded audio and video input signals to a peer device for decoding the encoded audio and video input signals to be provided for a second user of the peer device.

In an embodiment, the at least one memory and the computer program code configured to, with the at least one processor, cause the user device to:

receive audio signal from the second user of the peer device; and

receive audio signal of the second user of the peer device from the local AV device, wherein the audio and video input signals from the second user of the peer device are decoded and provided for the first user using the AV device; and

generate echo cancellation, based on the received audio signal from the second user, to reduce transmission of the audio signal of the second user from the user device back to the peer device.

In an embodiment, the at least one memory and the computer program code configured to, with the at least one processor, cause the user device to:

download from the wide-area public communication network a client application, the client application associated with an AV application of the AV device.

In an embodiment, the local connection comprises at least one of the following:

a cable connection;

a Bluetooth™ connection; and

a wireless local area network (WLAN) connection.

In an embodiment, the user device is associated with the AV device comprising a smart television device or a set-top box device with a network connection interface.

In an embodiment, the user device further comprises a second camera, wherein the user is configured to capture video input signals from a first user using at least one of the first and the second camera based on selection by the first user.

In an embodiment, the at least one memory and the computer program code configured to, with the at least one processor, cause the user device to:

connect the user device to a system server;

transmit authentication information from the user device to the system server for initiating account generation for at least one multimedia connection service;

receive client information from the system server;

determine a client application based on the received client information; and

establish a multimedia connection between the user device and the peer device utilizing the determined client application and the account generated by the system server.

According to a third example aspect of disclosed embodiments there is provided a computer program embodied on a computer readable medium comprising computer executable program code, which when executed by at least one processor of a user device, causes the user device to:

connect the user device via a wide-area public communication network to the peer device and via a local connection or the wide-area public communication network to a local AV device associated with the user device;

capture audio and video input signals from a first user using the camera and the microphone;

encode at least a part of the captured audio and video input signals to provide encoded audio and video input signals; and

transmit the encoded audio and video input signals to a peer device for decoding the encoded audio and video input signals to be provided for a second user of the peer device.

According to a fourth example aspect of disclosed embodiments there is provided a system comprising:

a user device of any of a second aspect;

an AV device associated with the user device; and

a peer device connected to the user device over a wide-area public communication network and via a local connection to the AV device associated with the user device to provide a multimedia connection.

In an embodiment, the system comprises a plurality of peer devices connected to the user device over a wide-area public communication network and via a local connection to the AV device associated with the user device to provide a multimedia connection between the user device, the AV device and the plurality of peer devices.

Different non-binding example aspects and embodiments of the disclosure have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The aspects of the disclosed embodiments will be described, by way of example only, with reference to the accompanying drawings, in which:

FIG. 1a shows a schematic picture of a system according to an aspect of the disclosed embodiments;

FIG. 1b shows another schematic picture of a system according to an aspect of the disclosed embodiments;

FIG. 2 presents an example block diagram of a user device;

FIG. 3 presents an example block diagram of an AV device;

FIG. 4 presents an example block diagram of a system server apparatus;

FIG. 5 presents an example block diagram of a peer device; and

FIG. 6 shows a flow diagram showing operations in accordance with an aspect of the disclosed embodiments.

### DETAILED DESCRIPTION

In the following description, like numbers denote like elements.

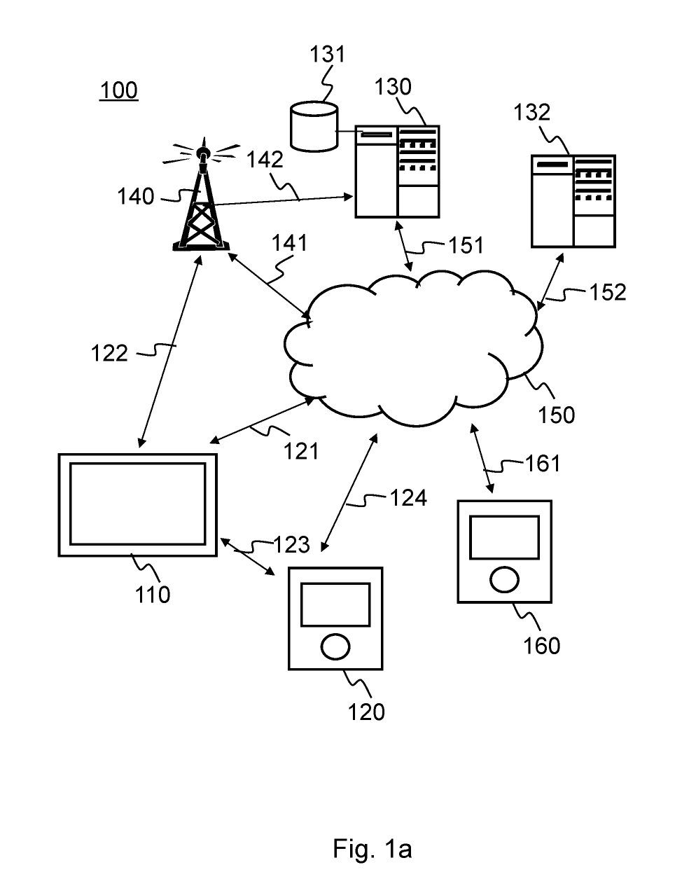

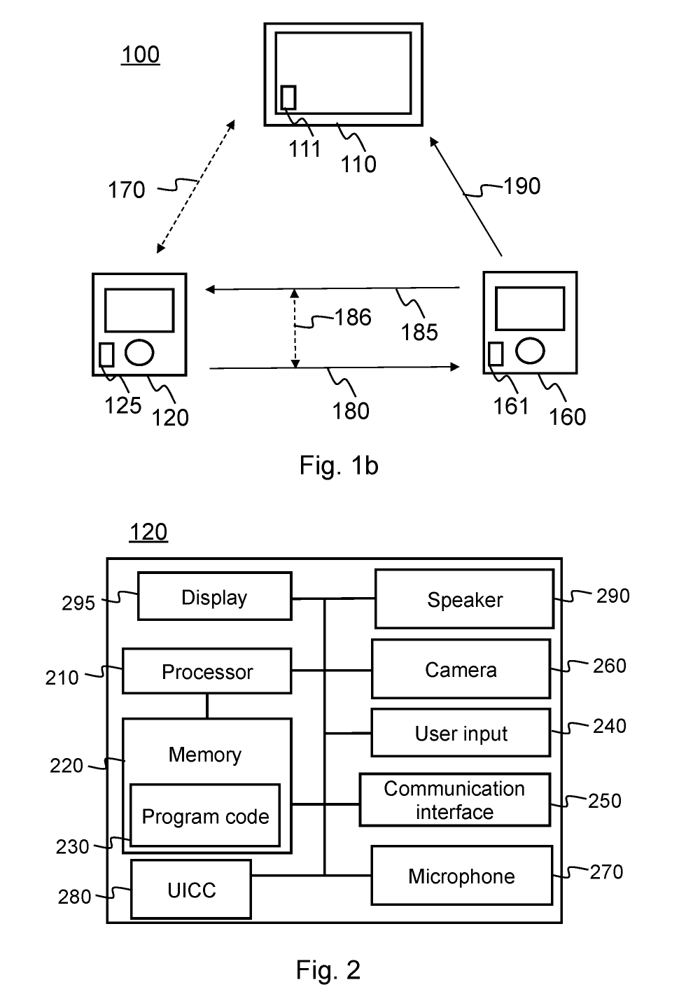

FIG. 1a shows a schematic picture of a system 100 according to an example embodiment. A user device 120 may comprise a mobile terminal comprising a communication interface, for example. The user device 120 is capable of downloading and locally executing software program code. The software program code may be a client application of a service whose peer application is running on a peer device 160, AV application is running on an AV device 110 and a possible server application is running on a server apparatus 130, 132 of the system 100. The user device 120 may comprise a camera for providing video stream for the multimedia connection and a microphone for providing audio stream for the multimedia connection, for example. The user device 120 is configured to be connectable to a public network 150, such as Internet, directly via local connection 124 or via a wireless communication network 140 over a wireless connection (not shown). The wireless connection may comprise a mobile cellular network or a wireless local area network (WLAN), for example. The wireless communication network may be to a public data communication network 150, for example the Internet, over a data connection 141. The user device 120 is configured to be connectable to the public data communication network 150, for example the Internet, directly over a data connection 124 that may comprise a fixed or wireless mobile broadband access.

In an embodiment, the system 100 comprises an AV device 110 configured to be connectable to the user device 120 over a local connection 123. The local connection 123 may comprise a wired connection or a wireless connection. The wired connection may comprise Universal Serial Bus (USB), High-Definition Multimedia Interface (HDMI), SCART interface or RCA interface, for example. The wireless connection may comprise Bluetooth™, Radio Frequency Identification (RF-ID) or wireless local area network (WLAN), for example. Near field communication (NFC) may be used for device identification between the AV device 110 and the user device 120, for example. The AV device 110 may comprise a television, for example. The AV device 110 may be connected directly to the public network 150, such as Internet, via direct local connection 121 or via a wireless cellular network connection 122, 140, 141.

In an embodiment, the user device 120 is a multimedia connection input device providing encoding of AV input data but using an external display apparatus, such as an AV device 110 for presenting multimedia connection related information to the user.

In an embodiment, the system 100 may comprise a server apparatus 130, which comprises a storage device 131 for storing service data, service metrics and subscriber information, over data connection 151. The service data may comprise configuration data, account creation data, peer-to-peer service data over cellular network and peer-to-peer service data over wireless local area network (WLAN), for example. The service metrics may comprise operator information for use in both user identification and preventing service abuse, as the device 120 and the user account are locked to a subscriber of an operator network using the subscriber identity module (SIM) of the device 120 and the service account details.

In an embodiment, a proprietary application in the user device 120 may be a client application of a service whose AV application is running in AV device 110, peer application is running in a peer device 160 and server application is running on the server apparatus 130 of the system 100. The proprietary application may capture the user input data for the videophone service and provide the user output data, from the peer, for the videophone service using output devices of the user device 120 or using the AV device 110 over the local connection 123. In an embodiment, configuration information or application download information between the user device 120, the peer device 160, the AV device 110 and the system server 130 may be transceived via the first wireless connection 122, 140, 142 automatically and configured by the server apparatus 130. Thus the user of the devices 110, 120, 160 may not need to do any initialization or configuration for the service. The system server 130 may also take care of account creation process for the service, such as videophone service between the user device 120 and the peer 160.

In an embodiment, the system 100 comprises a service provider server apparatus 132, for storing service data, service metrics and subscriber information, over data connection 152. The service data may comprise service account data, peer-to-peer service data and service software, for example. The service provider server apparatus 132 may provide the multimedia connection service for the user device 120 and the peer device 160, whereas the system server 130 is responsible for negotiating account information and client applications for the user device 120 with the service provider server apparatus 132.

In an embodiment, a proprietary application in the user device 120 may be a client application of a service whose server application is running on the server apparatus 132 of the system 100 and whose peer-to-peer client application is running on the peer-to-peer service apparatus 160. The proprietary application may capture the user input data for the videophone service and provide the user output data, from the peer, for the videophone service using, for example, the AV device 110. Furthermore, the system server apparatus 130 may automatically create a service account in the service server 132, for the user device 120. Thus the user of the user device 120 may not need to do any initialization or configuration for the service. Thus, the system server 130 may take care of account creation process for the service, such as multimedia connection service between the user device 120 and the peer 160.

In an embodiment, the system server apparatus 130 not only configures and creates the account, but may also facilitate pairing of the devices 110, 120 and associating devices 110, 120, 160 to the same multimedia connection.

Both the user device 110 and the AV device 120 need to download a service application, such as a client application (“User Device App”) and an AV application (“TV App”), respectively. The applications may be downloaded from the system server 130, for example. Thereafter the user device 110 is paired with the AV device 120 by the user. Pairing may be triggered by entering an identifier (e.g. a number) of the AV device application to the user device application.

After pairing the user device 110 (or the client application/User Device App) and the AV device 120 (or the AV application/TV App) remain aware of each other and “know” that they are supposed to be part of the same multimedia connection, for example a video call or a game stream. In practice this means that after one of the users of devices 110, 120, 160 dials/starts/initiates a connection or a call with another user, the different devices 110, 120, 160 that are connected to the server 130, are informed and facilitated by the server 120, how the connection should be set up between the different end-points 110, 120, 160. Once the multimedia connection has been set up properly, the AV streams between different devices 110, 120, 160 are opened in the right combination of peer-to-peer connections.

In an embodiment, pairing may comprise pairing of the user device 110 and the AV device 120, pairing of the client application “User Device App” and the AV application “TV App” or both.

In an embodiment, the user device 110 and the AV device 120 may be associated using one of many different methods, such as by entering a unique user ID or email address, by entering a unique token (which can be text or e.g. a QR code) or using, for example, some external service, such as Google's Nearby API which is a publish-subscribe API that lets you pass small binary payloads between internet-connected Android and iOS devices. Such devices do not have to be on the same local network, but they do have to be connected to the Internet 150. Nearby uses a combination of e.g. Bluetooth, Bluetooth Low Energy, Wi-Fi and near-ultrasonic audio to communicate a unique-in-time pairing code between devices. The server 130 may facilitate message exchange between devices 110, 120, 160 that detect the same pairing code. When a device detects a pairing code from a nearby device, it sends the pairing code to the Nearby Messages server 130 for validation, and to check whether there are any messages to deliver for the application's current set of subscriptions.

In an embodiment, the association of the devices 110, 120, 160 can be one-time or stored persistently on any of the devices 110, 120, 160 or the server 130, 131.

In an embodiment, for the purposes of a video call, before establishing the AV streams between the different devices all devices participating in the call must be made aware of how they are associated so that each device gets the correct streams.

FIG. 1b shows another schematic picture of a system 100 according to an example embodiment for selected parts of the system 100.

In an embodiment, a user is allowed to use a personal device 120, such as a smart phone, a tablet or a computer for both capturing video and audio, as well as encoding at least part of the audiovisual content used as a central part of a multimedia connection service consumed on a screen of an AV device 110, such as a TV screen. Examples of use cases include video calling on the TV and capturing video of a user while he is playing a game for the purposes of broadcasting that game play to other users over the network.

In an embodiment, a first user has an AV application 111 (“TV App”) installed in the AV device 110 (on a Smart TV or a set-top box or combination of those) and a client application 125 (“User Device App”) on a user device 120 (such a phone, tablet or computer) that can pair 170 itself with the “TV App” 111 to enable association of the devices 110, 120 and to further provide multimedia connection service.

In an embodiment, the user device 120 and the AV device 110 do not have to be connected locally for pairing. The user device 120 and the AV device 110 can be paired also so that the user device 120 is connected to a mobile network over connection 124 and therefrom to the Internet 150 for example, and the AV device 110 is connected over local connection 122 to a local WLAN network 140 and therefrom to the Internet 150, for example.

In an embodiment, a multimedia connection service, for example a video calling service, may be provided, wherein a first user may utilize an AV device 110, such as a smart television, for establishing a multimedia connection with a second user operating a peer device 160. The first user operating the AV device 110 has, for example, a client software AV application 111 (“TV App”) installed to the AV device 110 and another client software application 125 (“User Device App”) installed to a user device 120. The client software applications 111, 125 between the AV device 110 and the user device 120 are then paired 170. After pairing 170, the “User Device App” 125 of the user device 120 captures audio and video, encodes at least part of them and transmits the at least partially encoded audio and video data 180 to the peer device 160 for the second user. Simultaneously, the AV application 111 (“TV App”) of the AV device 110 receives and decodes live audio and video 190 sent by the second user operating the peer device 160 for the multimedia connection between the first and the second user. Furthermore, the client application 125 (“User Device App”) receives audio 185 from the peer device 160 in order to be able to manage echo cancellation 186 (i.e. so that the User App does not capture the sound from the AV device 110 and send it back to the second user operating the peer device 160. Thus “circulation” of sound may be prevented or at least minimized. Correspondingly, a client software application 161 (“User Device App” and /or “TV App”) may be installed in the peer device 160.

Disclosed embodiments provide multiple advantages. One advantage is that with the solution it is possible to use the camera and the microphone, as well as the hardware encoding capabilities of the user device 120 that the users in most cases already have in the user device 120, such a smart phone or a tablet. Thus the solution is much more accessible and cheaper (the only cost being the cost of the AV application 111 (“TV App”) and/or the client application 125 (“User Device App”)). Another advantage is that usability of the multimedia connection service is improved when the user may use the portable user device for audio and/or video capturing and the TV device 110 for peer audio and/or video output. The user device 120 typically has also better audio and/or video capturing devices than the AV device 110 and encoding features/capabilities that may be used for the multimedia connection.

In an embodiment, authentication of a user device 120 on a system server 130 may utilize hardware or SIM credentials, such as International Mobile Equipment Identity (IMEI) or International Mobile Subscriber Identity (IMSI). The user device 120 may transmit authentication information comprising IMEI and/or IMSI, for example, to the system server 130. The system server 130 authenticates the user device 120 by comparing the received authentication information to authentication information of registered users stored at the system server database 131, for example. Such authentication information may be used for pairing the devices to generate association between them for a multimedia connection.

In an embodiment, a peer-to-peer multimedia connection may be enabled by one of a multitude of client applications 125 that are components of a user device 120 application. Third party account credentials (usernames, passwords, etc.) may be hosted by the system server 130 and utilized when needed for video call setup (calling or answering), for example.

In an embodiment, a service web application may be used for configuration of a system. The service web application may be run on any user device 120 or a remote control apparatus, such as a personal computer connected to a public data network, such as Internet 150, for example. The control apparatus 170 may also be connected locally to the user device 120 over a local connection and utilize the network connections of the user device 120 for configuration purposes. The service web application of the control apparatus may provide searching/adding contacts, personalizing screen name, Wi-Fi Setup and user device 120 configurations, for example. The service web application of the control apparatus may be a general configuration tool for tasks being too complex to be performed on the user interface of the user device 120, such as entering text, for example.

In an embodiment, the remote control apparatus may be authenticated and configuration data sent from the control apparatus to the system server 130, 131 wherein configuration settings for the user device 120 are modified based on the received data. In an embodiment, the modified settings may then be sent to the user device 120 over the network 150 and the local connection or the wireless operator. For example, an SMS-based configuration message may be used to convey the configuration data.

FIG. 2 presents an example block diagram of a user device 120 in which various aspects of the disclosed embodiments may be applied. The user device 120 may be a user equipment (UE), user device or apparatus, such as a mobile terminal, a smart phone, a tablet, or other communication device comprising a communication interface, a camera and a microphone.

The general structure of the user device 120 comprises a user input device 240, a communication interface 250, a microphone 270, a camera 260, a processor 210, and a memory 220 coupled to the processor 210. The user device 120 further comprises software 230 stored in the memory 220 and operable to be loaded into and executed in the processor 210. The software 230 may comprise one or more software modules and can be in the form of a computer program product. The user device 120 may further comprise a universal integrated circuit card (UICC) 280.

In an embodiment, the user device 120 may comprise a display 295 for presenting information to a user of the apparatus 120. In case the apparatus 120 does not comprise the display 295, an external A/V apparatus 110 may be used for presenting information. The AV device 110 is in any case used for the video call related data.

The processor 210 may be, e.g., a central processing unit (CPU), a microprocessor, a digital signal processor (DSP), a graphics processing unit, or the like. FIG. 2 shows one processor 210, but the user device 120 may comprise a plurality of processors.

The memory 220 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The user device 120 may comprise a plurality of memories. The memory 220 may be constructed as a part of the user device 120 or it may be inserted into a slot, port, or the like of the user device 120 by a user. The memory 220 may serve the sole purpose of storing data, or it may be constructed as a part of an apparatus serving other purposes, such as processing data. Client application data for different services provided by service providers may be stored and run in the memory 220 as well as other user device 120 application data. A client application 125 (“User Device App”) is one such software application run by the processor with the memory.

The user input device 240 may comprise circuitry for receiving input from a user of the user device 120, e.g., via a keyboard, a touch-screen of the user device 120, speech recognition circuitry, gesture recognition circuitry or an accessory device, such as a headset or a remote controller, for example.

The camera 260 may be a still image camera or a video stream camera, capable for creating multimedia data for multimedia connection service. The device 120 may comprise several cameras, for example a front camera and a rear camera. The user of the device 120 may select used camera 260 via settings of the device 120 or the client application within the device 120.

In an embodiment, the device 120 may comprise several cameras 260 and/or several user devices 120 each comprising a camera 260 to provide 3D image/video capturing.

Human vision is binocular (stereoscopic): we have two sensors, our two eyes, and because they are horizontally separated we receive two images of the same scene with slightly different viewpoints. The brain superimposes and interprets the images to create a sensation of depth or three-dimensional vision.

In an embodiment, two parallel cameras 260 of a user device 120 are used to simultaneously capture scenes. When the images or video signal are shown at a peer device 160, the image recorded with the left camera is viewed only by the left eye, while the one recorded with the right camera is captured only by the right eye, for example. The reconstruction of images in three dimensions does bring something new because it allows the viewpoint to be freely selected after images have been recorded.

In an embodiment, at least two user devices 120 each comprising a camera 260 may be used for capturing 3D image/video signal. Both user devices 120 may be paired with the associated AV device 110 separately and transmitting encoded audio and video signals to the peer device 160 that receives and compiles the signals to generate 3D image/video signal for the second user. Alternatively a second user device 120 is connected over local connection to a first user device 120 to provide second camera signal and the first user device 120 captures first camera signal and generates from the first and the second camera signal a combined image or video signal with 3D effect. Then only the first user device 120 may be paired with the AV device 110 and the first user device 120 or the AV device 110 transmitting the encoded video signal with 3D effect to the peer device 160.

The speaker 290 is configured to notify a user of an incoming call and to provide other user alarm sounds. Such speaker is advantageous especially in case the A/V output apparatus 110 (e.g. TV) is in off/standby mode. The speaker 290 also allows the user to answer the incoming call and hear the caller before turning the A/V output apparatus 110 (e.g. TV) on. Thus, the user may start the conversation while searching for a remote control of the A/V output apparatus 110 (e.g. TV), for example.

The microphone 270 is configured to capture user speech information for the multimedia connection service.

In an embodiment, the microphone 270 may be used to disable the speaker 290 when identical audio output is detected, using the microphone 270, from an external source, such as the A/V output apparatus 110. The device speaker 290 may only be required when the A/V output apparatus 110 (e.g. TV) is switched off or operating at very low volumes. The additional audio output from the A/V output apparatus 110 (e.g. TV) is at a variable distance from the microphone 270 (measured in time), compared to the on-board speaker 290 (internal source), which is at a fixed/known distance from the microphone 270. The identical audio output may be detected based on audio data comparison and based on distance calculation the audio data source may be determined to be the A/V output apparatus 110 (e.g. TV) and the speaker 290 may be switched off automatically. The universal integrated circuit card (UICC) 280 is the smart card used in mobile terminals in GSM and UMTS networks. The UICC 280 ensures the integrity and security of all kinds of personal data, and it typically holds a few hundred kilobytes. In a GSM network, the UICC 280 contains a SIM application and in a UMTS network the UICC 280 contains a USIM application. The UICC 280 may contain several applications, making it possible for the same smart card to give access to both GSM and UMTS networks, and also provide storage of a phone book and other applications. It is also possible to access a GSM network using a USIM application and it is possible to access UMTS networks using a SIM application with mobile terminals prepared for this.

The communication interface module 250 implements at least part of data transmission. The communication interface module 250 may comprise, e.g., a wireless or a wired interface module. The wireless interface may comprise such as a WLAN, Bluetooth, infrared (IR), radio frequency identification (RF ID), NFC, GSM/GPRS, CDMA, WCDMA, or LTE (Long Term Evolution) radio module. The wired interface may comprise such as universal serial bus (USB), HDMI, SCART or RCA, for example. The communication interface module 250 may be integrated into the user device 120, or into an adapter, card or the like that may be inserted into a suitable slot or port of the user device 120. The communication interface module 250 may support one radio interface technology or a plurality of technologies. The communication interface module 250 may support one wired interface technology or a plurality of technologies. The user device 120 may comprise a plurality of communication interface modules 250.

A skilled person appreciates that in addition to the elements shown in FIG. 2, the user device 120 may comprise other elements, such as additional microphones, extra speakers, extra cameras, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the user device 120 may comprise a disposable or rechargeable battery (not shown) for powering when external power if external power supply is not available.

In an embodiment, the user device 120 comprises speech or gesture recognition means. Using these means, a pre-defined phrase or a gesture may be recognized from the speech or the gesture and translated into control information for the user device 120, for example.

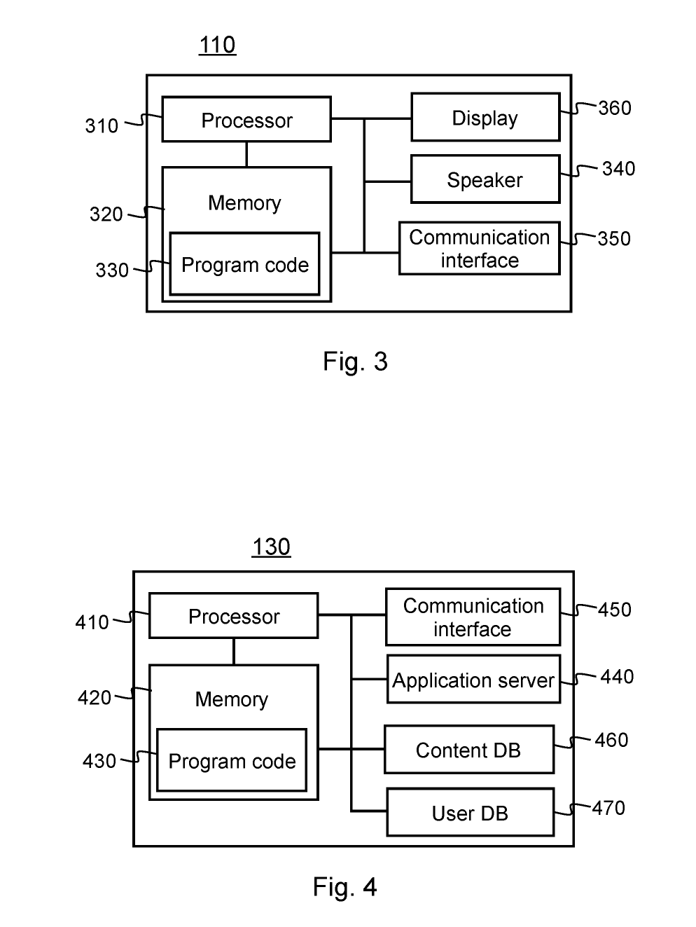

FIG. 3 presents an example block diagram of an AV device 110 in which various aspects of the disclosed embodiments may be applied. The A/V output apparatus 110 may be a television comprising a communication interface, a display and a speaker.

The general structure of the AV device 110 comprises a communication interface 350, a display 360, a processor 310, and a memory 320 coupled to the processor 310. The AV device 110 further comprises software 330 stored in the memory 320 and operable to be loaded into and executed in the processor 310. The software 330 may comprise one or more software modules and can be in the form of a computer program product. An AV application 111 (“TV App”) is one such software application.

The processor 310 may be, e.g., a central processing unit (CPU), a microprocessor, a digital signal processor (DSP), a graphics processing unit (GPU), or the like. FIG. 3 shows one processor 310, but the AV device 110 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The AV device 110 may comprise a plurality of memories. The memory 320 may be constructed as a part of the A/V output apparatus 110 or it may be inserted into a slot, port, or the like of the A/V output apparatus 110 by a user. The memory 320 may serve the sole purpose of storing data, or it may be constructed as a part of an apparatus serving other purposes, such as processing data.

The speaker 340 may comprise a loudspeaker or multiple loudspeakers with wired or wireless connections. Furthermore, the speaker 340 may comprise a jack for headphones and the headphones.

The display 360 may comprise a LED screen, a LCD screen or a plasma screen, for example.

The communication interface module 350 implements at least part of data transmission. The communication interface module 350 may comprise, e.g., a wireless or a wired interface module. The wireless interface may comprise such as a WLAN, Bluetooth, infrared (IR) or radio frequency identification (RF ID) radio module. The wired interface may comprise such as universal serial bus (USB), HDMI, SCART or RCA, for example. The communication interface module 350 may be integrated into the AV device 110, or into an adapter, card or the like that may be inserted into a suitable slot or port of the AV device 110. The communication interface module 350 may support one radio interface technology or a plurality of technologies. The communication interface module 350 may support one wired interface technology or a plurality of technologies. The AV device 110 may comprise a plurality of communication interface modules 350.

A skilled person appreciates that in addition to the elements shown in FIG. 3, the AV device 110 may comprise other elements, such as microphones, speakers, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the AV device 110 may comprise a disposable or rechargeable battery (not shown) for powering when external power if external power supply is not available.

FIG. 4 presents an example block diagram of a system server apparatus 130 in which various aspects of the disclosed embodiments may be applied.

The general structure of the system server apparatus 130 comprises a processor 410, and a memory 420 coupled to the processor 410. The server apparatus 130 further comprises software 430 stored in the memory 420 and operable to be loaded into and executed in the processor 410. The software 430 may comprise one or more software modules and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 130 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The system server apparatus 130 may comprise a plurality of memories. The memory 420 may be constructed as a part of the system server apparatus 130 or it may be inserted into a slot, port, or the like of the system server apparatus 130 by a user. The memory 420 may serve the sole purpose of storing data, or it may be constructed as a part of an apparatus serving other purposes, such as processing data.

The communication interface module 450 implements at least part of data transmission. The communication interface module 450 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as Ethernet or universal serial bus (USB), for example. The communication interface module 450 may be integrated into the server apparatus 130, or into an adapter, card or the like that may be inserted into a suitable slot or port of the system server apparatus 130. The communication interface module 450 may support one radio interface technology or a plurality of technologies. Configuration information between the user device 120 and the system server apparatus 130 may be transceived using the communication interface 450. Similarly, account creation information between the system server apparatus 130 and a service provider may be transceived using the communication interface 450.

An application server 440 provides application services e.g. relating to the user accounts stored in a user database 470 and to the service information stored in a service database 460. The service information may comprise content information, content management information or metrics information, for example.

A skilled person appreciates that in addition to the elements shown in FIG. 4, the system server apparatus 130 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

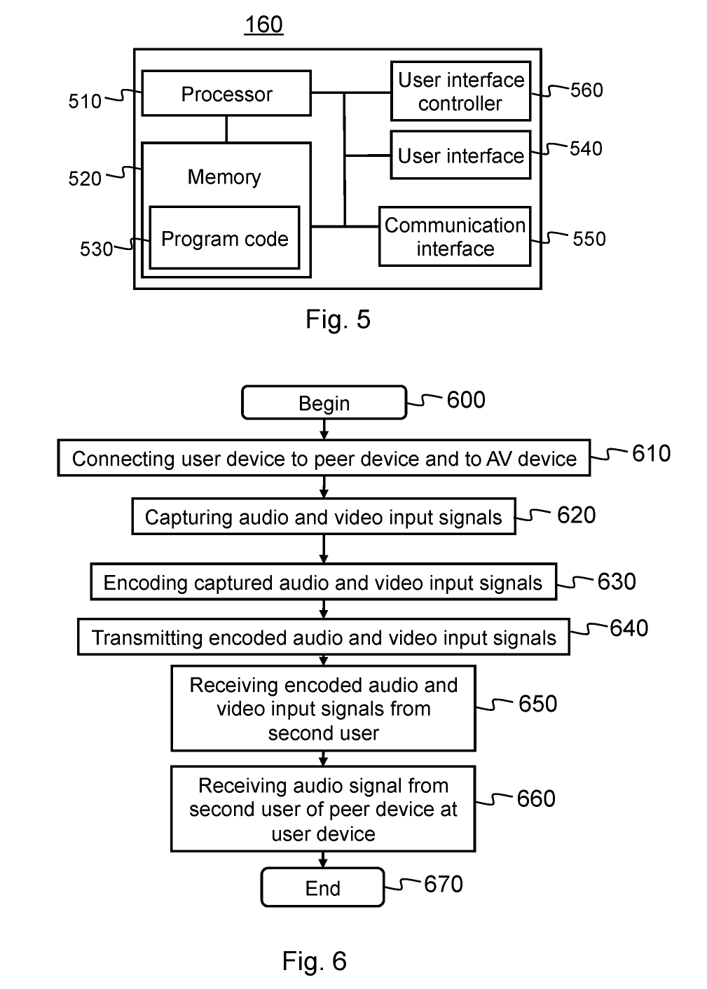

FIG. 5 presents an example block diagram of a peer apparatus 160 in which various aspects of the disclosed embodiments may be applied. The peer apparatus 160 may be a user equipment (UE), user device or apparatus, such as a mobile terminal, a smart phone, a laptop computer, a desktop computer or other communication device, such as a user device or an AV device. The peer apparatus 160 may comprise a corresponding user device 120 associated with an AV device 110, as in the first end of the connection.

The general structure of the peer apparatus 160 comprises a user interface 540, a communication interface 550, a processor 510, and a memory 520 coupled to the processor 510. The peer apparatus 160 further comprises software 530 stored in the memory 520 and operable to be loaded into and executed in the processor 510. The software 530 may comprise one or more software modules and can be in the form of a computer program product. The peer apparatus 160 may further comprise a user interface controller 560.

In an embodiment, the peer apparatus 160 may be remotely controlled by an external apparatus in a similar way as described before in this description between the user device 120 and the external control device.

The processor 510 may be, e.g., a central processing unit (CPU), a microprocessor, a digital signal processor (DSP), a graphics processing unit, or the like. FIG. 5 shows one processor 510, but the peer device 160 may comprise a plurality of processors.

The memory 520 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The peer apparatus 160 may comprise a plurality of memories. The memory 520 may be constructed as a part of the peer device 160 or it may be inserted into a slot, port, or the like of the peer device 160 by a peer user. The memory 520 may serve the sole purpose of storing data, or it may be constructed as a part of an apparatus serving other purposes, such as processing data.

The user interface controller 560 may comprise circuitry for receiving input from a user of the peer device 160, e.g., via a keyboard, graphical user interface shown on the display of the user interfaces 540 of the peer device 160, speech recognition circuitry, or an accessory device, such as a headset, and for providing output to the peer user via, e.g., a graphical user interface or a loudspeaker.

The communication interface module 550 implements at least part of radio transmission. The communication interface module 550 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB) or Ethernet, for example. The communication interface module 550 may be integrated into the peer apparatus 160, or into an adapter, card or the like that may be inserted into a suitable slot or port of the peer device 160. The communication interface module 550 may support one radio interface technology or a plurality of technologies. The peer device 160 may comprise a plurality of communication interface modules 550.

A skilled person appreciates that in addition to the elements shown in FIG. 5, the peer device 160 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the peer device 160 may comprise a disposable or rechargeable battery (not shown) for powering when external power if external power supply is not available.

In an embodiment, screen or application data sharing from the user device 120 to the peer device 160 is enabled during the multimedia connection.

In an embodiment, such method comprises selecting, by the first user, at least one of a plurality of applications 230 operating in the user device 120 to share with at least the peer device 160, and initiating application sharing in the user device 120 for the selected application 230, wherein an image of or data displayed at the display 295 of the user device 120 is transmitted as video input signals from the first user for the display 540 at the peer device 160, and wherein the second user is permitted to access or observe an initiated application 230, but is not permitted to perform any unauthorized operations on an application 230 being shared.

In an embodiment, the first user provides selection information via user interface 240 of the user device 120, and the selection information is configured to control whether video input signals captured from a camera 260 of the user device 120 or from the shared application 230 is encoded as video input signals from the first user by the user device 120 to provide encoded audio and video input signals.

In an embodiment, the first user provides selection information via user interface 240 of the user device 120, and the selection information is configured to control whether audio input signals captured from a microphone 270 of the user device 120 or from the shared application 230 is encoded as audio input signals from the first user by the user device 120 to provide encoded audio and video input signals.

In an embodiment, data shared by a shared application 230 of a user device 120 may comprise still pictures, video streams, audio streams of videos or music, for example.

In an embodiment, augmented screen or application data sharing from the user device 120 to the peer device 160 is enabled during the multimedia connection.

In an embodiment, such method comprises selecting, by the first user, at least one of a plurality of applications 230 operating in the user device 120 to share with at least the peer device 160, and initiating application sharing in the user device 120 for the selected application 230, wherein at least part of data provided by the shared application 230 is transmitted combined with video input signals from the first user for augmented display information at the peer device 160, and wherein the second user is permitted to access or observe an initiated application 230, but is not permitted to perform any unauthorized operations on an application 230 being shared.

In an embodiment, the first user provides selection information via user interface 240 of the user device 120, and the selection information is configured to control whether video input signals captured from a camera 260 of the user device only, or as augmented with the data provided by the shared application 230, is encoded as video input signals from the first user by the user device 120 to provide encoded audio and video input signals.

In an embodiment, the method further comprises generating from the video input signals captured from a camera 260 of the user device 120 as a first video stream; and generating from the at least part of the data provided by the shared application 230 as a second video stream.

In an embodiment, the method further comprises combining the first and the second video stream to provide the video input signals for encoding.

In an embodiment, the method further comprises encoding the first and the second video stream separately to provide first and second encoded video input, and transmitting the encoded audio and the first and the second video input signals from the user device 120 to the peer device 160, wherein the encoded audio and video input signals are decoded and provided for the second user of the peer device 160.

In an embodiment, the at least partially encoded audio and video data 180 in FIG. 1b may comprise only one video input signal set or a plurality of video signal sets (e.g. augmented data transmitted separately).

FIG. 6 shows a flow diagram showing operations in accordance with an example embodiment. In step 600, the method for providing a multimedia connection between a first user of a user device and a second user of a peer device is started. Such step may correspond to launching a multimedia connection client application in one of the devices 110, 120, 160. In step 610, the user device is connected via a wide-area public communication network to the peer device and via a local connection or the wide-area public communication network to a local AV device associated with the user device. In step 620, audio and video input signals are captured from the first user using the user device. In step 630, at least a part of the captured audio and video input signals from the first user by the user device are encoded to provide encoded audio and video input signals. In step 640, the encoded audio and video input signals are transmitted from the user device to the peer device, wherein the encoded audio and video input signals are decoded and provided for the second user of the peer device. In step 650, encoded audio and video input signals are received from the second user of the peer device at the local AV device, wherein the audio and video input signals from the second user of the peer device are decoded and provided for the first user using the AV device. In step 660, audio signal is received from the second user of the peer device at the user device, wherein the user device is configured to provide echo cancellation based on the audio signal from the second user to reduce transmission of the audio signal of the second user from the user device back to the peer device. The method is ended in step 670.

Various embodiments have been presented. It should be appreciated that in this document, words comprise, include and contain are each used as open-ended expressions with no intended exclusivity. If desired, the different functions discussed herein may be performed in a different order and/or concurrently with each other. Furthermore, if desired, one or more of the above-described functions may be optional or may be combined. Although various aspects of the disclosed embodiments are set out in the independent claims, other aspects comprise other combinations of features from the described embodiments and/or the dependent claims with the features of the independent claims, and not solely the combinations explicitly set out in the claims.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for providing a multimedia connection between a first user of a user device and a second user of a peer device comprising:
connecting the user device via a wide-area public communication network to the peer device and via a local connection or the wide-area public communication network to a local AV device associated with the user device;
capturing audio and video input signals from the first user using the user device;
encoding at least a part of the captured audio and video input signals from the first user by the user device to provide encoded audio and video input signals;
transmitting the encoded audio and video input signals from the user device to the peer device, wherein the encoded audio and video input signals are decoded and provided for the second user of the peer device; and
receiving encoded audio and video input signals from the second user of the peer device at the local AV device, wherein the audio and video input signals from the second user of the peer device are decoded and provided for the first user using the AV device.

2. The method of claim 1, further comprising:
receiving audio signal from the second user of the peer device at the user device, wherein the user device is configured to provide echo cancellation based on the audio signal from the second user to reduce transmission of the audio signal of the second user from the user device back to the peer device.

3. The method of claim 1, wherein the user device comprises a communication interface, a memory and a processor, configured to be capable of downloading and locally executing software program code, wherein the software program code comprising a client application for the multimedia connection, and the method further comprising:
pairing the user device and the AV device via the local connection to provide association between the devices for the multimedia connection.

4. The method of claim 1, wherein the user device comprises a communication interface, a memory and a processor, configured to be capable of downloading and locally executing software program code, wherein the software program code comprising a client application for the multimedia connection, and the method further comprising:
pairing the user device and the AV device via the wide-area public communication network to provide association between the devices for the multimedia connection.

5. The method of claim 1, further comprising:
transmitting the encoded audio and video input signals from the user device to the peer device directly without travelling through the AV device.

6. The method of claim 1, further comprising:
transmitting the encoded audio and video input signals from the user device to the peer device by relaying the encoded audio and video input signals through the AV device without decoding.

7. The method of claim 1, further comprising:
selecting, by the first user, at least one of a plurality of applications operating in the user device to share with at least the peer device; and
initiating application sharing in the user device for the selected application, wherein an image of data displayed at the user device is transmitted as video input signals from the first user for display at the peer device, and wherein the second user is permitted to access or observe an initiated application, but is not permitted to perform any unauthorized operations on an application being shared.

8. The method of claim 7, wherein the first user provides selection information via user interface of the user device, and the selection information is configured to control whether video input signals captured from a camera of the user device or from the shared application is encoded as video input signals from the first user by the user device to provide encoded audio and video input signals.

9. The method of claim 1, further comprising:
selecting, by the first user, at least one of a plurality of applications operating in the user device to share with at least the peer device; and
initiating application sharing in the user device for the selected application, wherein at least part of data provided by the shared application is transmitted combined with video input signals from the first user for augmented display at the peer device, and wherein the second user is permitted to access or observe an initiated application, but is not permitted to perform any unauthorized operations on an application being shared.

10. The method of claim 9, wherein the first user provides selection information via user interface of the user device, and the selection information is configured to control whether video input signals captured from a camera of the user device only, or as augmented with the data provided by the shared application, is encoded as video input signals from the first user by the user device to provide encoded audio and video input signals.

11. The method of claim 9, further comprising:
generating from the video input signals captured from a camera of the user device as a first video stream; and
generating from the at least part of the data provided by the shared application as a second video stream.

12. The method of claim 11, further comprising:
combining the first and the second video stream to provide the video input signals for encoding.

13. The method of claim 11, further comprising:
encoding the first and the second video stream separately to provide first and second encoded video input; and
transmitting the encoded audio and the first and the second video input signals from the user device to the peer device, wherein the encoded audio and video input signals are decoded and provided for the second user of the peer device.

14. A user device for providing a multimedia connection comprising:
a camera;
a microphone;
a communication interface for communicating with an AV device and a peer device;
at least one processor; and
at least one memory including computer program code;
the at least one memory and the computer program code configured to, with the at least one processor, cause the user device to:
connect the user device via a wide-area public communication network to the peer device and via a local connection or the wide-area public communication network to a local AV device associated with the user device;
capture audio and video input signals from a first user using the camera and the microphone;
encode at least a part of the captured audio and video input signals to provide encoded audio and video input signals; and
transmit the encoded audio and video input signals to a peer device for decoding the encoded audio and video input signals to be provided for a second user of the peer device.

15. The user device of claim 14, wherein the local connection comprises at least one of the following:
a cable connection;
a Bluetooth™ connection; and
a wireless local area network (WLAN) connection; and,
wherein the user device is associated with the AV device comprising a smart television device or a set-top box device with a network connection interface.

16. The user device of claim 14, further comprising a second camera, wherein the user is configured to capture video input signals from a first user using at least one of the first and the second camera based on selection by the first user.

17. The user device of claim 14, wherein the at least one memory and the computer program code configured to, with the at least one processor, cause the user device to:
connect the user device to a system server;
transmit authentication information from the user device to the system server for initiating account generation for at least one multimedia connection service;
receive client information from the system server;
determine a client application based on the received client information; and
establish a multimedia connection between the user device and the peer device utilizing the determined client application and the account generated by the system server.

18. A computer program embodied on a computer readable non-transitory medium comprising computer executable program code, which when executed by at least one processor of a user device, causes the user device to:
connect the user device via a wide-area public communication network to the peer device and via a local connection or the wide-area public communication network to a local AV device associated with the user device;
capture audio and video input signals from a first user using the camera and the microphone;
encode at least a part of the captured audio and video input signals to provide encoded audio and video input signals; and
transmit the encoded audio and video input signals to a peer device for decoding the encoded audio and video input signals to be provided for a second user of the peer device.

19. A system comprising:
a user device of claim 14;
an AV device associated with the user device; and
a peer device connected to the user device over a wide-area public communication network and via a local connection to the AV device associated with the user device to provide a multimedia connection.

20. A system of claim 19 further comprising a plurality of peer devices connected to the user device over a wide-area public communication network and via a local connection to the AV device associated with the user device to provide a multimedia connection between the user device, the AV device and the plurality of peer devices.
